(19) United States
(12) Patent Application Publication
(10) Pub. No.: US 2026/0310802 A1
(43) Pub. Date: Oct. 8, 2026

(54) Secure Backup Method

(71) Applicant: Siemens Aktiengesellschaft, Muenchen (DE)

(72) Inventors: Thomas ZESCHG, München (DE); Christian Peter FEIST, München (DE); Markus HEINTEL, München (DE); Christian MAGER, Erlangen (DE); Uwe SCHEUERMANN, Erlangen (DE); Guido SEEGER, Erlangen (DE); Ralf WAGNER, Erlangen (DE)

(21) Appl. No.: 19/478,914

(22) PCT Filed: Mar. 27, 2024
(86) PCT No.: PCT/EP2024/058327

§ 371 Date: Oct. 27, 2025

(30) Foreign Application Priority Data
Apr. 28, 2023 (EP) 23170831

(51) Int. Cl. G06F 21/60; G06F 11/1446; G06F 21/78

(52) U.S. Cl. CPC G06F 21/602; G06F 11/1464; G06F 21/78

(57) ABSTRACT

A technical system includes at least one first hardware component and at least one second hardware component, wherein digital information is assigned to the first hardware component, and wherein digital information that is generated by a backup method and is substantially identical in content to the digital information is cryptographically linked to the second hardware component of the technical system such that, when the first hardware component is replaced by a new first hardware component, the digital information is reassigned to the new first hardware component using the cryptographic linking of the digital information to the second hardware component.

### CROSS-REFERENCE TO RELATED APPLICATIONS

This is a U.S. national stage of application No. PCT/EP2024/058327 filed 27 Mar. 2024. Priority is claimed on European Application No. 23170831.4 filed 28 Apr. 2023, the content of which is incorporated herein by reference in its entirety.

### BACKGROUND OF THE INVENTION

### 1. Field of the Invention

The invention relates to a method for exchanging a first hardware component of a technical system, a technical system with at least one first hardware component and at least one second hardware component, and to a control system for a technical installation, in particular a production or process installation.

### 2. Description of the Related Art

Downtimes of industrial machines (for example, machine tools, automation systems) are generally very expensive and must therefore be kept as short as possible. As a result, the exchange of a defective component in a machine control system should be made as quick and uncomplicated as possible. To this end, it must in particular be ensured that the software and configuration are at the same level as before the component was exchanged. To achieve this, backup images of the individual software components (e.g., program binary files, and/or configuration data) are created and re-imported in the event of a replacement part.

However, such restoration becomes more difficult if the software executing on the components or the data stored by the components is cryptographically linked to the specific hardware. The backup images created can then only be restored on the respective components upon which they were originally generated. As a consequence, increased security of backup images is currently being dispensed with, i.e., the linking in the backup is cancelled, which, for example, enables arbitrary cloning of components.

RAID systems that are used primarily for redundant data storage in order to ensure a different level of fail-safe operation depending on the specific configuration are known. It is known from trusted platform modules (TPMs) that keys can be copied from one hierarchy to another in principle. Herein, the second hierarchy can be either on the same TPM or another TPM. In the case of TPM 2.0, the process is known as “duplication”, in the case of TPM 1.2, it was still called “migration”. The main purposes are to create backups and to provide a key on multiple devices.

It is known from memory encryption technology (RAM) AMD SEV that snapshots can be taken of virtual machines executing on a host or that virtual machines can be migrated live between hosts. However, in order to maintain memory encryption, the target hardware must be known in advance in both cases (see, e.g., 1.3.3 Snapshot and Migrate, as described in “SEV Secure Encrypted Virtualization API Specification Version 0.24, Advance Micro Devices, Revision 3.24, pg. 23, April 2020

U.S. Pub. No. 2016/0162418 Al discloses a restoration method for encryption keys for hard disks.

### SUMMARY OF THE INVENTION

In view of the foregoing, it is therefore an object of the present invention to be able to create backup images of components of a technical system such as an industrial machine such that they are cryptographically linked to the technical system and can only be restored in the event of a replacement part, but nevertheless the components of the technical system, such as those of the machine control system, can be exchanged. This and other objects and advantages are achieved in accordance with the invention by a technical system with at least one first hardware component and at least one second hardware component, by a control system for a technical system, in particular a production or process installation, and by a method for exchanging a first hardware component of a technical system, where digital information is assigned to the first hardware component, where the method comprises:
a) cryptographically linking the digital information to a second hardware component of the technical system,
b) replacing the first hardware component with a new first hardware component, and
c) reassigning the digital information to the first hardware component using the cryptographic linking of the digital information to the second hardware component.

The technical system can be a technical installation from the process industry, such as a chemical, pharmaceutical, petrochemical installation or an installation from the food and beverage industry. This also comprises any technical installations from the production industry, factories where, for example, cars or goods of all types are produced.

Technical installations suitable for performing the method in accordance with the invention can also come from the field of energy generation. Wind turbines, solar installations, power plants for energy generation or other machines are also covered by the term “technical system”.

It should be understood the technical system comprises at least two hardware components. Digital information is assigned to the first hardware component. Herein, in the broadest sense, digital information is information that is encoded in binary format and stored in a data memory. The digital information can preferably be a configuration of the first hardware component or a sequence program to be processed by the first hardware component. The information is assigned to the first hardware unit. This means that it relates to the first hardware unit itself or to the operation of the first hardware unit in the technical system.

In the context of the method in accordance with the invention, the first hardware component is to be replaced, for example, because it is defective. The new first hardware component is then to be assigned the digital information that was assigned to the old first hardware unit. For this purpose, the digital information was previously cryptographically linked to a second hardware component of the technical system. This ensures that the digital information is tamper-proof because the cryptographic linking between the digital information and the second hardware unit is not affected by the exchange of the first hardware unit. This cryptographic linking can now be used when reassigning the digital information to the (new) first hardware unit. Herein, the downtime of the technical system is kept low and the cryptographic linking to the second hardware unit makes arbitrary cloning of the first hardware component more difficult.

It is self-evident that the second hardware component can analogously have a cryptographic link to the first hardware component (or to one or more further hardware components), which can prove to be advantageous when exchanging the second hardware component.

The digital information is generated via a safeguarding method from digital information with identical content that is assigned to the first hardware component. In this context, this is also referred to as a backup of the digital information with identical content that is assigned to the first hardware component. Accordingly, the method is as follows:
generating a safeguarding or a backup of digital information assigned to the first hardware component,
cryptographically linking the digital information (backup) previously generated by the safeguarding method to a second hardware component of the technical system,
replacing the first hardware component with a new first hardware component, and
reassigning the digital information (backup) previously generated by the safeguarding method to the first hardware component using the cryptographic linking of the digital information (backup) to the second hardware component.

The digital information or the backup of the digital information generated by the safeguarding method can be stored in a memory of the second hardware component. However, it is also possible for the digital information or the backup of the digital information generated by the safeguarding method to be stored in another memory within the technical system or outside the technical system in a cloud-based environment.

In the context of a preferred embodiment of the invention, the cryptographic linking of the digital information (or the backup of the digital information) to the second hardware component occurs by encrypting (preferably with additional integrity protection) the digital information itself or a memory in which the digital information is stored.

Alternatively, the cryptographic linking of the digital information to the second hardware component can be established with a digital signature or a MAC (message authentication code).

Preferably, the memory in which the digital information with identical content is stored is implemented on the first hardware component, and the memory on which the digital information (i.e., the backup) generated by the safeguarding method is stored is implemented on the second hardware component, where the cryptographic linking of the digital information generated by the safeguarding method to the second hardware component occurs via keys specific to the respective hardware component.

The communication channel used to exchange information between the first hardware component and the second hardware component is preferably likewise protected by a cryptographic method (not necessarily of the same type) in order to be able to counter attempted attacks.

Advantageously, the cryptographic linking of the digital information generated by the safeguarding method to the second hardware component occurs via keys specific to the respective hardware component, where the key specific to the second hardware unit is used to link the digital information (i.e., the backup) generated by the safeguarding method of the first hardware unit to the second hardware unit.

Additionally, the digital information (or the backup) can be cryptographically linked to a third hardware component of the technical system, where the digital information is reassigned to the first hardware component after the replacement of the first hardware component using the cryptographic linking of the digital information to the second hardware component and to the third hardware component. Linking to two additional hardware components can further increase security without having to significantly increase the effort required for this.

Generally speaking, the digital information can be cryptographically linked to m further hardware components of the technical system, where m represents a natural number greater than one, and where the digital information is reassigned to the first hardware component after the replacement of the first hardware component using the cryptographic linking of the digital information to a subset of the m further hardware components that can be defined for a technical system. Herein, the digital information (or the backup) can each be completely linked to the second hardware component, thus further increasing security. For resource reasons, it is likewise advantageous if in each case only a specific part of the digital information or its backup is linked to the further hardware component. Herein, each further hardware component can be allocated a specific part of the digital information. Methods known per se can be used for the reassignment of the distributed information to the replaced first hardware component. In particular, herein, not all m further hardware components need to be used. It is also possible that only a part of the m further hardware components may be sufficient to realize the reassignment of the digital information or the backup.

The objects and advantages are also achieved in accordance with the invention by a technical system with at least one first hardware component and at least one second hardware component, where digital information is assigned to the first hardware component, and where digital information generated via a safeguarding method and with substantially identical content to the digital information is cryptographically linked to the second hardware component of the technical system such that, when the first hardware component is replaced by a new first hardware component, the digital information is reassigned to the first hardware component using the cryptographic linking of the digital information to the second hardware component.

The technical system preferably has a security entity, in particular a certification authority and/or a registration authority in the context of a public-private key infrastructure.

The objects and advantages are also achieved in accordance with the invention by a control system for a technical installation, in particular a production or process installation or a motor as a technical installation, where the control system comprises at least one operator station server as a first hardware component and at least one automation device as a second hardware component, and where the technical system is configured in accordance with the disclosed embodiments.

In the present context, a control system should be understood to mean a computer-aided technical system comprising functionalities for displaying, operating and controlling the technical installation. The control system can also comprise sensors for ascertaining measured values and various actuators. In addition, the control system can comprise “process-related” or “production-related” components that serve to actuate the actuators or sensors. Furthermore, the control system can inter alia have means for visualizing the process-engineering installation and for engineering. The control system can optionally also comprise further computing units for more complex control systems and systems for data storage and data processing.

The control system can additionally have at least one operator station client that can be used by the operator for operator control and monitoring of the technical system, where the operator station server is configured to generate the corresponding visualization information and transmit it to the operator station client.

In the present disclosure, an “operator station server” should be understood to mean a server that centrally captures data from an operating and monitoring system and, generally, alarm and measured archives of a (process) control system of a technical installation and makes them available to users. The operator station server generally establishes a communication link to automation systems of the technical installation and forwards data from the technical installation to “clients” that serve for operator control and monitoring of the operation of the individual functional elements of the technical installation. The operator station server can have client functions to access the data (archives, messages, tags variables) of other operator station servers. This means that images of the operation of the technical installation on the operator station server can be combined with variables from other operator station servers (server-server communication). The operator station server can be a SIEMENS SIMATIC PCS 7 Industrial Workstation server, but is not limited to this.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will become clearer and more plainly comprehensible in conjunction with the following description of exemplary embodiments explained in more detail in conjunction with the drawings, in which:

FIG. 1 shows a schematic illustration of a first and a second hardware component in accordance with a first embodiment of the invention;

FIG. 2 shows a schematic illustration of the first and the second hardware component of FIG. 1 in accordance with a second embodiment of the invention;

FIG. 3 shows a schematic illustration of the first hardware component and a plurality of further hardware components in in accordance with the invention; and

FIG. 4 is a flowchart of the method in accordance with the invention.

### DETAILED DESCRIPTION OF THE EXEMPLARY EMBODIMENTS

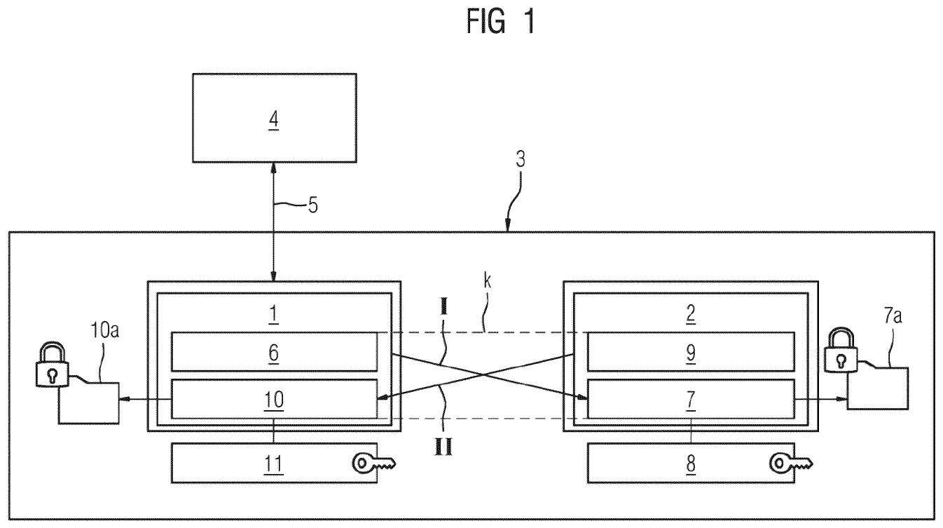

FIG. 1 is a schematic depiction of an operator station server 1 as a first hardware component and an automation device 2 as a second hardware component of a control system 3 as a technical system for a technical installation. In addition to the operator station server 1 and the automation device 2, the control system 3 comprises an operator station client 4 via which an operator can access the control system for the purpose of operator control and monitoring of the technical installation. The operator station server 1 and the operator station client 4 are connected to one another via a terminal bus 5 and optionally to further components (not shown) of the control system 3 such as an archive server.

Configuration data 6 is stored on the operator station server 1 as digital information that is relevant for the operation of the operator station server 1 in the control system 3. In a first step I, the configuration data 6 of the operator station server 1 is duplicated by a safeguarding method that is known per se and transmitted to a memory 7 of the automation device 2, where it is stored as a backup 7a. The backup 7a of the configuration data 6 of the operator station server 1 is cryptographically linked to the automation device 2. This occurs by encrypting the data memory 7 using a hardware trust anchor 8 of the automation device 2.

Analogously, in a second step II, digital information 9 from the automation device 2 is duplicated by a safeguarding method that is known per se and transmitted to a memory 10 of the operator station server 1, where it is stored as a digital backup 10a. The backup 10a of the digital information 9 from the automation device 2 is cryptographically linked to the operator station server 1. This occurs by encryption of the data memory 10 using a hardware trust anchor 11 of the operator station server 1.

The transmission channel K between the operator station server 1 and the automation device 2 is cryptographically secured in order to prevent manipulation. A Transport Layer Security (TLS) based communication method can be used for this purpose, for example.

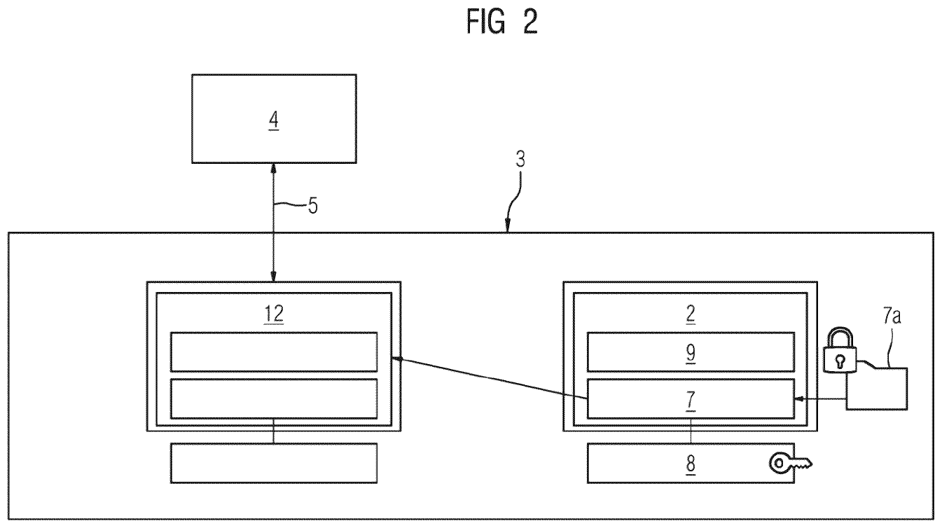

This is subsequently exchanged due to a failure of the operator station server 1. The method steps explained below are represented schematically in FIG. 2. The new operator station server 12 only has its factory settings and does not have the configuration data 6 relevant for its operation in the control system. Therefore, the backup 7a is transferred from the memory 7 of the automation device 2 to the new operator station server 12 and assigned to the operator station server 12. Herein, the hardware trust anchor 8 of the automation device 2 is used to decrypt the backup 7a. In this case, the backup 10a of the automation device 2 was stored in the memory 10 of the old operator station server 1 and must be regenerated. However, it is also possible that the backup 7a, 10a is, for example, stored in a cloud-based environment.

In one embodiment, in order to calculate the signature, it is not the complete backup image 7a of the configuration data 6 that is transmitted to the automation device 2 as a second hardware component, but only a hash value thereof. The calculated signature is transferred to the memory in which the backup image 7a is stored (this does not necessarily have to be the memory 7 of the automation device 2).

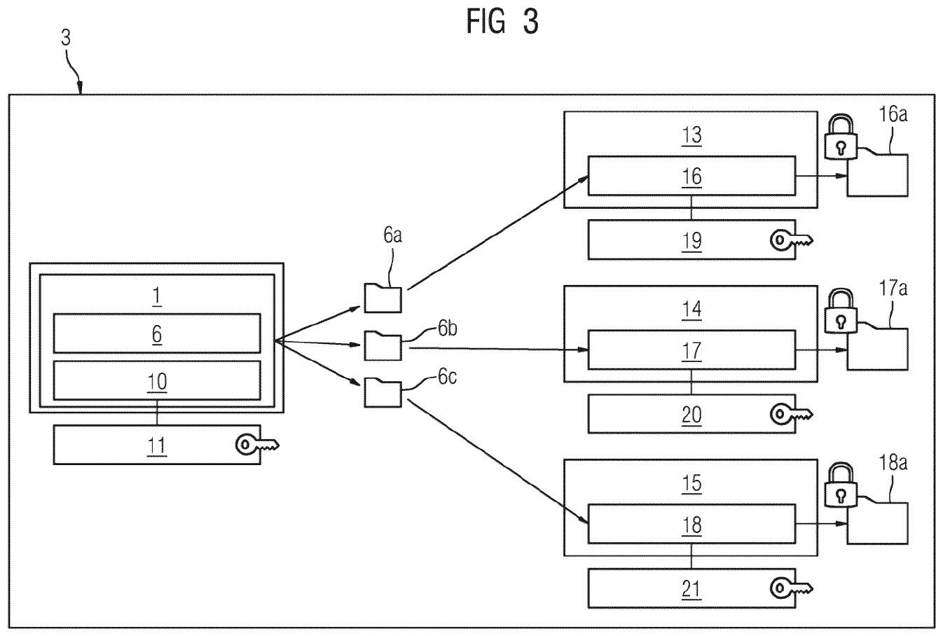

FIG. 3 shows the division of the configuration data 6 into three sub-packages 6a, 6b, 6c. The first sub-package 6a is stored in a memory 16 of a third hardware component 13 as a backup 16a. The second sub-package 6b is stored as a backup 17a in a memory 17 of a fourth hardware component 14 and the third sub-package 6c is stored in a memory 18 of a fifth hardware component 15 as a backup 18a. As is known from RAID systems (for example, RAID 5), this can be achieved with a defined pattern and additional checksums. This has the advantage that, depending on the configuration, a specific number of the further hardware components 13, 14, 15 present is required to restore the configuration file 6 from the backup parts 16a, 16b, 16c for an exchanged operator station server 1.

The configuration data 6 can be divided either by the operator station server 1 itself and distributed to the other hardware components 13, 14, 15, or by a central backup component (not shown). The final backup image can be stored in the form of the individual parts 16a, 16b, 16c on the respective hardware components 13, 14, 15 (as shown in FIG. 3). However, it is also possible to create a manifest describing the distribution to the individual components. The merged image can in turn be stored locally outside the machine, in a backend system or in the cloud.

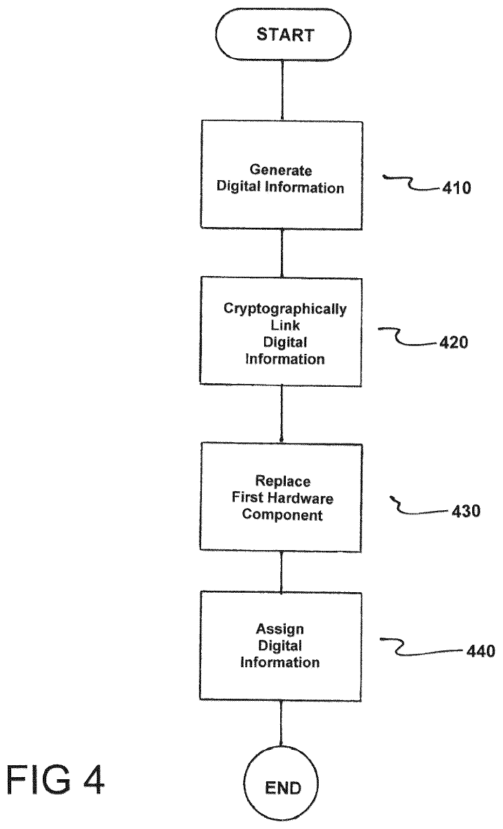

FIG. 4 is a flowchart of the method for exchanging a first hardware component 1, 12 of a technical system, where digital information 6, 7a is assigned to the first hardware component 1.

The method comprises a) generating digital information with identical content from the digital information 6, 7a assigned to the first hardware component 1 via a safeguarding method, as indicated in step 410.

Next, b) the digital information 6, 7a generated in step 410 is cryptographically linked to a second hardware component 2 of the technical system, as indicated in step 420.

Next, c) the first hardware component 1 is replaced with a new first hardware component 12, as indicated in step 430.

Next, d) assigning the digital information 6, 7a generated in step 410 is assigned to the new first hardware component 12 utilizing the cryptographic linking of the digital information 6, 7a generated in step 410 to the second hardware component 2, as indicated in step 440.

Although the invention has been illustrated and described in greater detail by the preferred exemplary embodiment, the invention is not restricted by the disclosed examples and other variations can be derived herefrom by the person skilled in the art without departing from the scope of protection of the invention as defined by the claims in conjunction with the description.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for exchanging a first hardware component of a technical system, digital information being assigned to the first hardware component, the method comprising:
a) generating digital information with identical content from the digital information assigned to the first hardware component via a safeguarding method;
b) cryptographically linking the digital information generated in step a) to a second hardware component of the technical system;
c) replacing the first hardware component with a new first hardware component;
d) assigning the digital information generated in step a) to the new first hardware component utilizing the cryptographic linking of the digital information generated in step a) to the second hardware component.

14. The method as claimed in claim 13, wherein the digital information comprises one of (i) a configuration of the first hardware component and (ii) a sequence program to be processed by the first hardware component.

15. The method as claimed in claim 13, wherein the digital information is stored in a memory of the second hardware component.

16. The method as claimed in claim 13, wherein the digital information is stored outside the second hardware component in the technical system.

17. The method as claimed in claim 14, wherein the digital information is stored outside the second hardware component in the technical system.

18. The method as claimed in claim 16, wherein the digital information is stored in a cloud-based environment outside the technical system.

19. The method as claimed in claim 17, wherein the digital information is stored in a cloud-based environment outside the technical system.

20. The method as claimed in claim 13, wherein the cryptographic linking of the digital information to the second hardware component occurs by encrypting a memory in which the digital information is stored.

21. The method as claimed in claim 20, wherein the memory in which the digital information with identical content is stored is implemented on the first hardware component, and the memory upon which the digital information generated by the safeguarding method is stored is implemented on the second hardware component; and wherein the cryptographic linking of the digital information generated by the safeguarding method to the second hardware component occurs via keys specific to the respective hardware component.

22. The method as claimed in claim 13, wherein a communication channel between the first hardware component and the second hardware component is protected by a cryptographic method.

23. The method as claimed in claim 13, wherein the cryptographic linking of the digital information generated by the safeguarding method to the second hardware component occurs via keys specific to the respective hardware component; and wherein the key specific to the second hardware component is linked to the digital information generated by the safeguarding method.

24. The method as claimed in claim 13, wherein the digital information is additionally cryptographically linked to a third hardware component of the technical system; and
wherein reassignment of the digital information to the first hardware component after the replacement of the first hardware component occurs utilizing the cryptographic linking of the digital information to the second hardware component and to the third hardware component.

25. The method as claimed in claim 13, wherein the digital information is additionally cryptographically linked to m further hardware components of the technical system;
wherein m represents a natural number greater than one; and wherein reassignment of the digital information to the first hardware component after the replacement of the first hardware component occurs utilizing the cryptographic linking of the digital information to a part of the m further hardware components.

26. A technical system comprising:
at least one first hardware component; and
at least one second hardware component;
wherein digital information is assigned to the first hardware component; and
wherein digital information generated via a safeguarding method and substantially identical in content with the digital information has a cryptographic link to the second hardware component of the technical system such that, when the first hardware component is replaced by a new first hardware component, the digital information is reassigned to the new first hardware component utilizing the cryptographic linking of the digital information to the second hardware component.

27. A control system for a technical installation, the control system comprising:
at least one operator station server forming a first hardware component; and
at least one automation device forming a second hardware component;
wherein the control system is configured as the technical system as claimed in claim 26.

28. The control system as claimed in claim 27, wherein the technical installation comprises a production or process installation.
